(19) United States
(12) Patent Application Publication
(10) Pub. No.: US 2024/0352386 A1
(43) Pub. Date: Oct. 24, 2024

(54) METHOD OF PREPARING ALCOHOL-FREE BEER

(71) Applicant: HEINEKEN SUPPLY CHAIN B.V, Zoeterwoude (NL)

(72) Inventors: Tom Daniël Elink SCHUURMAN, Zoeterwoude (NL); Ikechukwu Victor OFODU, Zoeterwoude (NL)

(21) Appl. No.: 18/758,312

(22) Filed: Jun. 28, 2024

Related U.S. Application Data
(63) Continuation of application No. PCT/EP2023/050024, filed on Jan. 2, 2023.

(30) Foreign Application Priority Data
Dec. 31, 2021 (EP) 21218501.1

(51) Int. Cl. C12C 12/04; A23L 2/38; C12C 11/00; C12C 11/02

(52) U.S. Cl. CPC C12C 12/04; A23L 2/382; C12C 11/003; C12C 11/02

(57) ABSTRACT

The invention provides a method of producing an alcohol-free beer, said method comprising:
providing a vessel containing wort;
inoculating the wort with yeast and allowing the yeast to form a settled layer on the bottom of the vessel or a floating layer below the surface of the wort;
fermenting the inoculated wort at a temperature of −3 to 5° C. for a period of at least 8 hours to produce a fermented wort;
separating the fermented wort from the yeast to produce alcohol-free beer;
   wherein:
   one or more pitchings of additional yeast into the inoculated wort are applied during the fermentation; or
   one or more disruptions of the layer of yeast are applied during the fermentation; or
   at the beginning of the fermentation the wort is inoculated with at least 3×10⁶ yeast cells per mL of wort.

The present method offers the advantage that it yields an alcohol-free beer in which undesirable ‘worty’ flavour notes are substantially reduced.

### CROSS-REFERENCE TO RELATED APPLICATIONS

This application is a continuation of International Patent Application No. PCT/EP2023/050024 filed Jan. 2, 2023, which application claims priority to European Patent Application No. 21218501.1 filed Dec. 31, 2021, the contents of which are both incorporated herein by reference in their entireties.

### TECHNICAL FIELD OF THE INVENTION

The present invention relates to a method of producing alcohol-free beer using so called “cold contact fermentation”. More particularly, the present invention provides such a method of producing alcohol-free beer in which undesirable ‘worty’ flavour notes are substantially reduced.

The invention also relates an alcohol-free beer that can be obtained by such a process.

### BACKGROUND OF THE INVENTION

Beer is a universally popular beverage, consumed worldwide. In recent years, the beer market has witnessed a significant increase in the consumption of alcohol-free beer. This increase is triggered by concerns about health and safety, and is expedited by innovations that have substantially improved the quality of alcohol-free beers.

Alcohol-free beers are produced by two basic processes. One applies classical brewing processes followed by alcohol removal by techniques such as reverse osmosis, dialysis or evaporation. The other approach aims at reducing the formation of alcohol during fermentation by contacting boiled wort with yeast under conditions that minimise fermentative production of alcohol. This type of process is commonly referred to as “restricted alcohol fermentation”.

Cold contact fermentation (or cold contact process) is a form of restricted alcohol fermentation that employs a combination of low fermentation temperatures and extended fermentation contact times. Alcohol-free beers that have been produced using cold contact fermentation typically have an off-flavour note that is commonly referred to as ‘worty’. This worty flavour note has been attributed to aldehydes that are formed during wort boiling, notably methional (3-methylthiopropionaldehyde), 3-Methylbutanal, 2-methylbutanal and 2-methypropanal.

Methional is formed by the interaction of α-dicarbonyl compounds (intermediate products in the Maillard reaction) with methionine through the Strecker degradation reaction. Similarly, 3-methylbutanal, 2-methylbutanal and 2-methyl propanal are formed by the interactions of α-dicarbonyl compounds with leucine, isoleucine and valine respectively. Since these aldehydes are formed through the Strecker degradation reaction, they are sometimes referred to as “Strecker aldehydes”.

In alcohol-free beers that have been produced by cold contact fermentation the contribution of the aforementioned worty flavour substances to the overall flavour of the beer is very prominent. This is partly due the fact that the concentrations of these flavour substances in such alcohol-free beers are higher than in alcoholic beers. In addition, the absence of alcohol in alcohol-free beers increases the intensity with which these flavour substances are perceived by consumers.

Gernat et al. (Aldehydes as Wort Off-Flavours in Alcohol-Free Beers—Origin and Control, Food and Bioprocess Technology (2019), 13(2), 195-216.) discuss different technologies for reducing the aldehyde content of alcohol-free beer. These technologies include:
adsorptive removal using various adsorption materials;
separation by extraction;
removal by pervaporation;
removal during dealcoholisation;
reduction of aldehydes during cold contact fermentation.

Perpète et al. (How to improve the enzymatic worty flavour reduction in a cold contact fermentation, Food Chemistry (2000), 70, 457-462) report that enzymatic removal of Strecker aldehydes by brewer's yeast, Saccharomyces cerevisiae, is always limited to 60-85% of the initial concentration, whatever the fermentation conditions. According to the authors, this asymptotic reduction pattern leads to residual concentrations imparting the well-known unpleasant worty taste to alcohol-free beers. Low-energy binding to flavanoids is shown to hinder more complete enzymatic reduction in the cold contact fermentation process

Chandrasekhar et al. (Production of Low Alcohol Beer and Alcohol-free Beer using a Combination of High Temperature Mashing and Cold Contact Fermentation, FERMENT, INSTITUTE OF BREWING, GB, vol. 7, no. 4, 1 Jan. 1994, pages 241-244) describes a study in which the effect of mashing temperature on the quality of low alcohol beer, that had been produced by cold contact fermentation, was investigated. In one of the experiments a fermenter was used that was set up with carbon dioxide percolation.

US 2013/0280399 describes a method for producing an alcohol-free beer-like malt beverage comprising reducing the off-flavour originated from wort by adding terpene, e.g. terpinolene.

WO 2020/055233 describes a process of producing a non-alcoholic fermented beer having an alcohol content of less than 1.0% ABV, wherein either the fermentation produces a non-alcoholic fermented wort or wherein the fermentation produces an alcoholic fermented wort and alcohol is subsequently removed to produce a non-alcoholic fermented wort or a non-alcoholic beer; and wherein the heated wort, the non-alcoholic fermented wort and/or the non-alcoholic beer is contacted with a hydrophobic silicate-based molecular sieve containing SiO₂ and Al₂O₃ in a molar ratio of at least 15.

### SUMMARY OF THE INVENTION

The inventor has unexpectedly discovered that in cold contact fermentation the concentrations of Strecker aldehydes can be reduced very effectively by:
(a) pitching additional yeast into the wort during fermentation; or
(b) disrupting the layer of yeast during fermentation by sparging, recirculation or mechanical action; or
(c) inoculating the wort with a very large amount of yeast.

Although the inventor does not wish to be bound by theory, it is believed that the capacity of yeast to remove Strecker aldehydes during cold contact fermentation is limited due to the fact that during fermentation the yeast cells are contained in a quiescent layer that has formed on the bottom of the fermenter or below the surface of the wort. The inventor believes that the further yeast cells are removed from the interface between yeast layer and wort, the less they can contribute to the removal of the Strecker aldehydes. Furthermore, it is believed that a yeast cell's capacity of removing Strecker aldehydes is limited. As a result only a fraction of the yeast's capacity to remove Strecker aldehydes is utilized during cold contact fermentation. Once the yeast cells close to the interface have reached the limit of their removal capacity, no further reduction of Strecker aldehyde content is achieved.

The inventor has found that the capacity of yeast to remove Strecker aldehydes during cold contact fermentation can be increased substantially by pitching additional yeast during fermentation or by disrupting the yeast layer during fermentation by means of sparging, recirculation or mechanical. Inoculation with a very large amount of yeast was also found to increase removal of Strecker aldehydes.

Accordingly, the present invention provides a method of producing an alcohol-free beer, said method comprising:
providing a vessel containing at least 10 hL of wort having a gravity of 5 to 25° P;
inoculating the wort with at least 10⁵ cells/mL of yeast and allowing the yeast to form a settled layer on the bottom of the vessel or a floating layer below the surface of the wort;
fermenting the inoculated wort at a temperature of −3 to 5° C. for a period of at least 8 hours to produce a fermented wort;
separating the fermented wort from the yeast to produce alcohol-free beer;
   wherein:
   (a) one or more pitchings of additional yeast into the inoculated wort are applied during the fermentation, each of said one or more pitchings providing a dosage of 10⁵ to 5×10⁶ yeast cells per mL of wort, and at least one of said one or more pitchings being applied at least 1 hour after the inoculation; or
   (b) one or more disruptions of the layer of yeast are applied during the fermentation, at least one of the one or more disruptions being applied at least 1 hour after the inoculation or continuing until at least 1 hour after the inoculation; or
   (c) at the beginning of the fermentation the wort is inoculated with at least 3×10⁶ yeast cells per mL of wort; and
   wherein the method does not comprise addition of Strecker aldehydes selected from 2-methylbutanal, 3-methylbutanal and methional.

Also provided is an alcohol-free beer having an ethanol content of less than 0.5 vol. %, said alcohol-free beer comprising:
20-90 g/L of fermentable sugars selected from glucose, maltose, maltotriose and combinations thereof;
0-6 μg/L of 2-methylbutanal;
0-14 μg/L of 3-methylbutanal;
0-12 μg/L of 2-methylpropanal;
0-6 μg/L of methional;
8-100 μg/L of phenyl acetaldehyde; and
30-500 μg/L of furfural;
   wherein the combination of 2-methylbutanal, 3-methylbutanal, 2-methylpropanal and methional is present in a combined concentration of X μg/L; phenyl acetaldehyde is present in a concentration of Y μg/L and furfural is present in a concentration of Z μg/L; and wherein:
X:Y≤1:2; and/or
X:Z≤. 1:20.

### DETAILED DESCRIPTION OF THE INVENTION

A first aspect of the invention relates to a method of producing an alcohol-free beer, said method comprising:
providing a vessel containing at least 10 hL of wort having a gravity of 5 to 25° P;
inoculating the wort with at least 10⁵ cells/mL of yeast and allowing the yeast to form a settled layer on the bottom of the vessel or a floating layer below the surface of the wort;
fermenting the wort at a temperature of −3 to 5° C. for a period of at least 8 hours to produce a fermented wort;
separating the fermented wort from the yeast to produce alcohol-free beer;
   wherein:
   (a) one or more pitchings of additional yeast into the inoculated wort are applied during the fermentation, each of said one or more pitchings providing a dosage of 10⁵ to 5×10⁶ yeast cells per mL of wort, and at least one of said one or more pitchings being applied at least 1 hour after the inoculation; or
   (b) one or more disruptions of the layer of yeast are applied during the fermentation, at least one of the one or more disruptions being applied at least 1 hour after the inoculation or continuing until at least 1 hour after the inoculation; or
   (c) at the beginning of the fermentation the wort is inoculated with at least 3×10⁶ yeast cells per mL of wort; and
   wherein the method does not comprise addition of Strecker aldehydes selected from 2-methylbutanal, 3-methylbutanal and methional.

The term “or” as used herein should be construed as “and/or”, unless specified otherwise.

The term “a” or “an” as used herein 5 is defined as “at least one” unless specified otherwise.

The wort that is employed in the present method preferably has a gravity of 8 to 22° P, more preferably a gravity of 10 to 20° P.

At the moment of inoculation, the wort preferably contains at least 20 μg/L of 2-methylbutanal, more preferably at least 30 μg/L of 2-methylbutanal and most preferably 50-300 μg/L of 2-methylbutanal.

At the moment of inoculation, the wort preferably contains at least 40 μg/L of 3-methylbutanal, more preferably at least 60 μg/L of 3-methylbutanal and most preferably 100-600 μg/L of 3-methylbutanal.

At the moment of inoculation, the wort preferably contains at least 20 μg/L of 2-methylpropanal, more preferably at least 30 μg/L of 2-methylpropanal and most preferably 80-600 μg/L of 2-methylpropanal.

Methional is preferably contain in the wort at the moment of inoculation in a concentration of at least 16 μg/L, more preferably of at least 40 μg/L, most preferably of 60-300 μg/L.

The wort that is inoculated in the present method preferably is a hopped wort, containing contains at least 1.0 mg/L iso-alpha acids, more preferably at least 1.5 mg/L and most preferably 2.0-80 mg/L of iso-alpha acids, said iso-alpha acids being selected from isohumulone, isoadhumulone, isocohumulone, reduced versions of these iso-alpha acids and combinations thereof. Reduced versions of iso-alpha acids are tetrahydroiso-alpha-acids and hexahydroiso-alpha-acids.

The present method can suitably be operated at an industrial scale. Preferably, the amount of wort that is contained in the vessel is at least 20 hL, most preferably 30 to 5,000 hL.

The yeast that is employed in the present method is preferably selected from Saccharomyces pastorianus, Saccharomyces uvarum, Saccharomyces cerevisiae and combinations thereof. Most preferably, the yeast is Saccharomyces pastorianus.

The present method may be carried out using either a bottom-fermenting yeast that forms a yeast layer on the bottom of the fermenter or a top-fermenting yeast that forms a floating layer at the surface of the wort. Preferably, the yeast is a bottom-fermenting yeast and the yeast is allowed to form a layer on the bottom of the fermenter after inoculation.

The wort may be inoculated with yeast in the form of dry yeast or wet yeast. Preferably, the yeast that is employed in the method is wet yeast. The wet yeast that is employed preferably has an ethanol content of 0-3 wt. %, more preferably of 0-1 wt. %.

In a preferred embodiment, the yeast used for inoculation is obtained from the production of alcoholic beer and ethanol is removed therefrom prior to inoculation by washing.

The layer of yeast that is formed after inoculation preferably has a thickness of at least 0.1 mm, more preferably a thickness of at least 0.5 mm, most preferably a thickness of 1 to 40 mm.

In case the present method comprises pitching of additional yeast or disruption of the yeast layer, the wort is preferably inoculated with at least 3×10⁵ cells/mL of yeast, more preferably with 10⁶ to 10⁷ cells/mL of yeast.

The present method preferably employs a fermentation period of least 16 hours, more preferably of 20 to 120 hours and most preferably of 24 to 72 hours.

In the present method the inoculated wort is preferably fermented at a temperature of −2 to 4° C. for at least 16 hours, more preferably for 20 to 120 hours and most preferably for 24 to 72 hours.

According to a particularly preferred embodiment, the inoculated wort is fermented at a temperature of −1 to 2° C. for at least 16 hours, more preferably for 20 to 120 hours and most preferably for 24 to 72 hours.

The yeast may be separated from the fermented wort using solid-liquid separation techniques known in the art. Preferably, yeast is separated from the fermented wort by filtration, centrifugation or decanting.

In the embodiment of the present method that comprises application of one or more pitchings of additional yeast during fermentation, the method preferably comprises 1 to 100 pitchings providing a dosage of 10⁵ to 5×10⁶ yeast cells per mL of wort. More preferably, the method comprises 2 to 50 pitchings providing a dosage of 10⁵ to 5×10⁶ yeast cells per mL of wort. Most preferably, the method comprises 3 to 20 pitchings providing a dosage of 10⁵ to 5×10⁶ yeast cells per mL of wort.

The time interval between the inoculation and the first pitching of the one or more pitchings and the time interval between successive additional pitchings preferably is in the range of 0.5 to 50 hours, more preferably of 1 to 30 hours.

In the embodiment of the present method that comprises one or more disruptions of the yeast layer, the one or more disruptions of the yeast layer are preferably achieved by sparging, recirculation or mechanical action.

In accordance with one preferred embodiment of the present method, the yeast layer is disrupted continuously during the fermentation over a period of at least 0.5 hour, more preferably over a period of at least 1 hour, even more preferably over a period of at least 2 hours and most preferably over a period of 3 to 120 hours.

In accordance with another preferred embodiment, the yeast layer is disrupted intermittently. Preferably, in accordance with this embodiment, the method preferably comprises 1 to 1,000 of such disruptions of the yeast layer. More preferably, the method comprises 2 to 200 disruptions of the yeast layer. Most preferably, the method comprises 3 to 60 disruptions of the yeast layer.

The time interval between the inoculation and the first disruption of the one or more disruptions of the yeast layer and the time interval between successive disruptions of the yeast layer preferably is in the range of 0.1 to 50 hours, more preferably of 0.5 to 30 hours.

Disruption of the yeast layer by sparging preferably comprises sparging with nitrogen or carbon dioxide. Most preferably carbon dioxide is used for sparging.

Disruption by recirculation may suitably be achieved by pumping wort out of the vessel and re-introducing the wort into the vessel in such a way that the yeast layer is disrupted.

Examples of mechanical action that may be used to disturb the yeast layer are stirring, shaking and cutting.

In the embodiment of the present method in which the wort is inoculated with a very large amount of yeast, preferably the wort is inoculated with at least 5×10⁶ cells of yeast per mL wort, more preferably with 10⁷ to 10⁸ cells of yeast per mL of wort.

The concentration of 2-methylbutanal in the wort is preferably reduced by at least 70%, more preferably by at least 80% and most preferably by at least 90% by the fermentation step.

The concentration of 3-methylbutanal in the wort is preferably reduced by at least 70%, more preferably by at least 80% and most preferably by at least 90% by the fermentation step.

The concentration of 2-methylpropanal in the wort is preferably reduced by at least 70%, more preferably by at least 80% and most preferably by at least 90% by the fermentation step.

The concentration of methional in the wort is preferably reduced by at least 70%, more preferably by at least 80% and most preferably by at least 90% by the fermentation step.

During the fermentation step of the present method, virtually no ethanol is produced by the yeast. Thus, the bulk of the fermentable sugars that are present in the wort before fermentation are also present in the alcohol-free that is obtained by the present method. Accordingly, in a preferred embodiment, the alcohol-free beer contains 20-90 g/L, more preferably 25-80 g/L and most preferably 30-65 g/L of fermentable sugars selected from glucose, maltose, maltotriose and combinations thereof.

According to a particularly preferred embodiment, the present method yields an alcohol-free beer comprising:
0-6 μg/L, preferably 0-5 μg/L of 2-methylbutanal;
0-14 μg/L, preferably 0-7 μg/L of 3-methylbutanal;
0-12 μg/L, preferably 0-6 μg/L of 2-methylpropanal; and
0-6 μg/L, preferably 0-4 μg/L of methional.

The ethanol content of the alcohol-free beer that is obtained by the present method preferably is 0-0.5 vol. %, more preferably 0-0.2 vol. %, most preferably 0-0.1 vol. %.

Another aspect of the present invention relates to an alcohol-free beer having an ethanol content of less than 0.5 vol. %, said alcohol-free beer comprising:
20-90 g/L of fermentable sugars selected from glucose, maltose, maltotriose and combinations thereof;
0-6 μg/L of 2-methylbutanal;
0-14 μg/L of 3-methylbutanal;
0-12 μg/L of 2-methylpropanal;
0-6 μg/L of methional;
8-100 μg/L of phenyl acetaldehyde; and
30-500 μg/L of furfural
   wherein the combination of 2-methylbutanal, 3-methylbutanal, 2-methylpropanal and methional is present in a combined concentration of X μg/L; phenyl acetaldehyde is present in a concentration of Y μg/L and furfural is present in a concentration of Z μg/L; and wherein:
X:Y≤1:2; and/or
X:Z≤. 1:20.

The alcohol-free beer of the present invention is preferably obtainable, more preferably the alcohol-free beer is obtained by the production method described herein before.

Preferably, the alcohol-free beer contains 25-80 g/L, more preferably 30-65 g/L and most preferably 35-60 g/L of fermentable sugars selected from glucose, maltose, maltotriose and combinations thereof.

According to a particularly preferred embodiment, the alcohol-free contains 15-60 g/L, more preferably 20-50 g/L and most preferably 25-45 g/L of maltose.

The alcohol-free beer of the present invention preferably contains 0-5 μg/L of 2-methylbutanal, more preferably 0.2-3 μg/L of 2-methylbutanal.

The alcohol-free beer preferably contains 0-7 μg/L of 3-methylbutanal, more preferably 0.2-5 μg/L of 3-methylbutanal.

The alcohol-free beer preferably contains 0-6 μg/L of 2-methylpropanal, more preferably 0.2-4 μg/L of 2-methylpropanal.

The alcohol-free beer preferably contains 0-4 μg/L of methional, more preferably 0.2-3 μg/L of methional.

Furfural is an aldehyde that is a Maillard reaction product that is formed during wort boiling. Unlike the Strecker aldehydes, the concentration of furfural is not substantially reduced during the fermentation step of the present method. Preferably, the alcohol-free beer contains 40-400 μg/L of furfural, more preferably, 50-300 μg/L of furfural, Phenylacetaldehyde is a Strecker aldehyde that is derived from phenylalanine. Phenylacetaldehyde is removed less efficiently by yeast during cold contact fermentation than small Strecker aldehydes mentioned above. Preferably, the alcohol-free beer contains 10-80 μg/L of furfural, more preferably, 12-50 μg/L of phenylacetaldehyde.

According to a particularly preferred embodiment of the alcohol-free beer, methional and furfural are present in a weight ratio of less than 1:30, more preferably in a weight ratio of 1:50 to 1:300.

According to a particularly preferred embodiment, the above mentioned ratio X:Y does not exceed 1:3. Most preferably, the ratio X:Y is in the range of 1:20 to 1:4.

According to a particularly preferred embodiment, the above mentioned ratio X:Z does not exceed 1:30. Most preferably, the ratio X:Z is in the range of 1:200 to 1:40.

The alcohol-free beer of the present invention preferably contains at least 1.0 mg/L iso-alpha acids, more preferably at least 1.5 mg/L and most preferably 2.0-80 mg/L of iso-alpha acids, said iso-alpha acids being selected from isohumulone, isoadhumulone, isocohumulone, reduced versions of these iso-alpha acids and combinations thereof. Reduced versions of iso-alpha acids are tetrahydroiso-alpha-acids and hexahydroiso-alpha-acids.

The ethanol content of the alcohol-free beer preferably is 0-0.2 vol. %, more preferably 0-0.1 vol. %, most preferably 0.001-0.05 vol. %.

According to a particularly preferred embodiment, the alcohol-free beer of the present invention is an alcohol-free lager beer.

Preferably, the alcohol-free beer is a pale beer measuring 4-15, more preferably 5-11 EBC units.

The invention is further illustrated by the following non-limiting examples.

### EXAMPLES

### Example 1

Alcohol-free lager beers were produced from the same wort (15° P) by means of different cold contact fermentation processes, using a bottom fermenting, lager beer yeast.

Strecker aldehydes (methional, 2 methylbutanal, 3 methylbutanal, 2 methylpropanal) were analysed at the end of the fermentation by headspace solid-phase micro-extraction (HS-SPME) using a method adapted from Vesely et al. (Analysis of Aldehydes in Beer Using Solid-Phase Microextraction with On-Fiber Derivatization and Gas Chromatography/Mass Spectrometry, Journal of Agricultural and Food Chemistry, (2003); 51(24), 6941-6944.), in a GC-MS (Agilent 7890A and 5975C MSD) and a 30 cm×0.25 mm×0.25 μm VF17MS column. The derivatization reaction was carried out with O-(2,3,4,5,6-pentafluorobenzyl)-hydroxylamine (PFBOA). Helium was used as the carrier gas at a flow rate of 1 mL/min.

Beer A (control) was prepared by inoculating the wort with 50 g/hL wet yeast (collected at the end of a regular lager beer fermentation) at the start of the cold contact fermentation. The temperature was kept between 0-2° C. and the fermentation time was 48 hours, after which the yeast was removed from the beer by membrane filtration.

Beer 1 was prepared in the same way as Beer A, except that after 24 hours, the yeast was removed by means of membrane filtration, after which the wort was pitched with 125 g/hL wet yeast (collected at the end of a regular beer lager beer fermentation) to start a second fermentation, again at a temperature of 0-2° C. for 24 hours.

Beer 2 was prepared in the same way as Beer 1, except that the wort was inoculated with 150 g/hL washed yeast and that after 24 hours yeast was removed and the wort was pitched with 150 g/hL of washed yeast. The washed yeast was prepared by collecting yeast at the end of a regular lager beer fermentation. This yeast was washed twice by removing the liquid (beer) by means of centrifugation and subsequently resuspension in cold de-aerated water.

Beer 3 was prepared was prepared in the same way as Beer A, except that the wort was inoculated with 300 g/hL washed yeast that had been prepared in the same as described above.

One gram of wet yeast corresponds to about 2.8×10⁹ yeast cells.

The concentrations of four Strecker aldehydes were determined in each of Beers A. 1, 2 and 3. The results are shown in Table 1.

TABLE 1

| | Strecker aldehydes (μg/L) | | | |
|---|---|---|---|---|
| | 2-methyl | 2-methyl | 3-methyl | |
| Beer | propanal | butanal | butanal | methional |
| A (control) | 38 | 44 | 81 | 34 |
| 1 | 31 | 14 | 36 | 18 |
| 2 | 11 | 3 | 13 | 3 |
| 3 | 14 | 5 | 22 | 6 |

### Example 2

Alcohol-free lager beers were produced from the same wort (15° P) by means of different cold contact fermentation processes. Again the combined concentration of the 4 Strecker aldehydes was determined for each of the beers.

Beer 1 was prepared by inoculating the wort with 175 g/hL wet yeast (collected at the end of a regular lager beer fermentation). The temperature was 0-2° C. and the fermentation time was 48 hours, after which the yeast was removed from the beer by membrane filtration.

Beer 2 was prepared by in the same way as Beer 1, except that the fermenting wort was intermittently sparged with CO₂ for 15 minutes every 2 hours during 24 hours to disturb the yeast layer. After 24 hours the CO₂ sparging was stopped.

The concentrations of four Strecker aldehydes were determined in each of Beers 1 and 2. The results are shown in Table 2.

TABLE 2

Strecker aldehydes (μg/L)

| | 2-methyl | 2-methyl | 3-methyl | |
|---|---|---|---|---|
| Beer | propanal | butanal | butanal | methional |
| 1 | 107 | 27 | 66 | 22 |
| 2 | 26 | 6 | 10 | 16 |

1. A method of producing an alcohol-free beer, the method comprising:
(a) providing a vessel containing at least 10 hL of wort having a gravity of 5 to 25° P;
(b) inoculating the wort with at least 10⁵ cells/mL of yeast and allowing the yeast to form a settled layer on the bottom of the vessel or a floating layer below the surface of the wort;
(c) fermenting the wort at a temperature of −3 to 5° C. for a period of at least 8 hours to produce a fermented wort;
(d) separating the fermented wort from the yeast to produce alcohol-free beer;
wherein:
(i) one or more pitchings of additional yeast into the inoculated wort are applied during the fermentation, each of the one or more pitchings providing a dosage of 10⁵ to 5×10⁶ yeast cells per mL of wort, and at least one of the one or more pitchings being applied at least 1 hour after the inoculation; or
(ii) one or more disruptions of the layer of yeast are applied during the fermentation, at least one of the one or more disruptions being applied at least 1 hour after the inoculation or continuing until at least 1 hour after the inoculation; or
(iii) at the beginning of the fermentation the wort is inoculated with at least 3×10⁶ yeast cells per mL of wort; and
wherein the method does not comprise addition of Strecker aldehydes selected from 2-methylbutanal, 3-methylbutanal and methional.

2. The method according to claim 1, wherein the wort contains at least 20 μg/L of 2-methylbutanal.

3. The method according to claim 1, wherein the wort contains at least 40 μg/L of 3-methylbutanal.

4. The method according to claim 1, wherein the wort contains at least 16 μg/L of methional.

5. The method according to claim 1, wherein the yeast is selected from Saccharomyces pastorianus, Saccharomyces uvarum, Saccharomyces cerevisiae and combinations thereof.

6. The method according to claim 5, wherein the yeast is Saccharomyces pastorianus.

7. The method according to claim 1, wherein the yeast is a bottom-fermenting yeast and the yeast is allowed to form a layer on the bottom of the fermenter after inoculation.

8. The method according to claim 1, wherein the layer of yeast has a thickness of at least 0.1 mm.

9. The method according to claim 1, wherein the method comprises 1 to 100 pitchings of additional yeast in a dosage of 10⁵ to 5×10⁶ yeast cells per mL of wort, and wherein the time interval between the inoculation and the first of the 1 to 100 pitchings and the time interval between successive additional pitchings is in the range of 0.5 to 50 hours.

10. The method according to claim 1, wherein the method comprises 1 to 1,000 disruptions of the layer of yeast, and wherein the time interval between the inoculation and the first of the 1 to 1,0000 disruptions and the time interval between successive disruptions is in the range of 0.1 to 50 hours.

11. The method according to claim 1, wherein the yeast layer is disrupted continuously during the fermentation over a period of at least 0.5 hour.

12. An alcohol-free beer having an ethanol content of less than 0.5 vol. %, the alcohol-free beer comprising:
(i) 20-90 g/L of fermentable sugars selected from glucose, maltose, maltotriose and combinations thereof;
(ii) 0-6 μg/L of 2-methylbutanal;
(iii) 0-14 μg/L of 3-methylbutanal;
(iv) 0-12 μg/L of 2-methylpropanal;
(v) 0-6 μg/L of methional;
(vi) 8-100 μg/L of phenyl acetaldehyde; and
(vii) 30-500 μg/L of furfural
wherein the combination of 2-methylbutanal, 3-methylbutanal, 2-methylpropanal and methional is present in a combined concentration of X μg/L; phenyl acetaldehyde is present in a concentration of Y μg/L and furfural is present in a concentration of Z μg/L; and wherein: X:Y≤1:2; and/or X:Z≤. 1:20.

13. The alcohol-free beer according to claim 12, comprising 15-60 g/L of maltose.

14. The alcohol-free beer according to claim 12, comprising 0.2-3 μg/L of methional.

15. The alcohol-free beer according to claim 12, wherein methional and furfural are present in a weight ratio of less than 1:30.
